(19) United States
(12) Patent Application Publication
(10) Pub. No.: US 2006/0147594 A1
(43) Pub. Date: Jul. 6, 2006

(54) Apparatus and process for reducing microbial contamination of nuts

(75) Inventors: David Long, Merced, CA (US); Jack Wilkey, Turlock, CA (US); Charles I. Jahn, Denair, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hilltop Ranch, Inc., Ballico, CA (US)

(21) Appl. No.: 11/287,706

(22) Filed: Nov. 21, 2005

Related U.S. Application Data
(60) Provisional application No. 60/629,865, filed on Nov. 19, 2004.

(51) Int. Cl. A23L 3/16

(52) U.S. Cl. 426/521

(57) ABSTRACT

The invention provides methods and devices for reducing microbial contamination of nuts. An enclosed vertical path permits nuts to descend from an upper elevation to a lower elevation. Steam introduced into the enclosed vertical path from two or more orifices contacts the nuts to accomplish pasteurization.

### CROSS-REFERENCES TO RELATED APPLICATIONS

This application claims priority from U.S. Provisional Application No. 60/629,865, filed Nov. 19, 2004, the contents of which are hereby incorporated by reference.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

Almonds are California's largest agricultural crop, with an annual value of $1.5 billion; California produces approximately 80% of the world's almonds and almost 100% of the almonds sold in the United States. Raw nuts, such as raw almonds, are used as an ingredient in many foods. Unfortunately, the harvesting of almonds and other nuts can cause the nuts to come into contact with microbial pathogens. For example, when ripe and dried on an almond tree, almonds within their shells or pods have a tendency to drop naturally from the tree. Because the nuts do not all drop from the tree at a uniform time, however, almond harvesting usually involves encouraging them to drop by shaking the trees, or at least at the almond-bearing limbs of the trees, and allowing the almonds contained in their shells or pods to fall to the orchard floor. Thereafter, the fallen almonds within their shells or pods are collected for harvest from the orchard ground. The almonds within their shells or pods are then routed to a so-called “sheller” where the shells or pods are removed. When the shells or pods are removed, the almonds have a skin placed over the “meat” of the almond nut.

Because of the nature of the harvest, it can be anticipated that, at least in some cases, the shell or pod may become contaminated with pathogens such as E. coli or Salmonella. During and after the shelling process, it is possible for the shelled almonds to be contaminated on their exterior surface with pathogens. Rare case are known in which contaminated raw almonds caused illness in consumers. See, e.g., Isaacs et al., J. Food Protection, 68(1):191-198(8) (2005); Chan et al., Can Commun Dis Rep 28:97-9 (2002). Almond processing is a low margin, high-dollar, volume business. Thus, reducing any costs associated with reducing bacterial contamination while still protecting consumers from pathogens would be desirable.

Caramelizing almonds is known. In caramelizing almonds, the almonds are first whetted and thereafter baked at a relatively high temperature for an extended period of time. While such carmelization naturally will sterilize the exterior of the almonds against pathogens, it changes the taste, appearance, and properties of the almonds are changed. For example, carmelization is frequently used where it is desired to thinly slice almonds as an ingredient for food such as candy bars. Without carmelization, raw untreated almonds cannot be thinly sliced. Further, overheating nuts can denature oils in the nut, as well as alter the characteristics of the nut. Either of these degradations can render the nuts unsuitable for sale.

Borrowing from the terminology used with respect to milk and other beverages, nuts processors use the term “pasteurization” to refer to treating nuts to reduce bacterial contamination. This art-recognized usage will be employed here. Raw nuts, such as almonds, are susceptible to contamination by bacteria, such as Salmonella. The organism of concern for almond processors, in particular, Salmonella enterica serotype Enteritidis (SE), Phage Type 30 (SE PT30), and the industry goal is to reduce any SE PT30 organisms present by 5 logs, or 100,000 fold.

Current devices for reducing bacterial contamination, or pasteurizing, nuts include a horizontal steam pasteurization conveyor produced by Ventilex USA Inc. (Cincinnati, Ohio), which combines steam, fluidization, cooling, and a conveyor. The conveyor is perforated and steam is introduced through the perforations to heat nuts in the conveyor. To expose all the nut surface to the steam, and to fluidize the nuts so that they move along the conveyor, the conveyor is vibrated. This machinery is complicated, difficult to clean, uses considerable energy to generate the steam, and takes up considerable floor space (that is, it has a large “footprint”). Other systems for nut processing include a shaking mechanism, again requiring complicated machinery.

Accordingly, it would be desirable to have a method and apparatus able to reduce or eliminate microbial contamination on the surface of nuts, either prior to or following shelling, while using less energy and taking up less floor space than are currently available. Further, it would be desirable for this reduction in microbial contamination to be as consistent as possible so that the need further processing of the nuts can be reduced or eliminated.

### BRIEF SUMMARY OF THE INVENTION

The invention provides processes and apparatuses for reducing bacterial contamination of nuts.

In a first group of embodiments, the invention provides processes comprising providing an enclosed path permitting a nut to descend from an upper elevation to a lower elevation, the path being positioned at an angle between and including 75 degrees to and including 90 degrees from the horizontal and having four or more orifices disposed along the path, introducing steam into said enclosed path from the four or more orifices; and introducing the nut into said enclosed path, thereby contacting it with said steam for a time sufficient to kill bacteria on said nut, thereby reducing bacterial contamination on said nut. In some embodiments, the steam is introduced at a pressure higher than atmospheric pressure. In some embodiments, the steam is maintained in said path as a pressurized wet steam so as to create a high dew point temperature approaching 212° F. In some embodiments, the steam pressure is 3 pounds or less higher than atmospheric pressure. The nut can be an almond, cashew, walnut, pecan, macadamia, Brazil nut, pistachio, hazelnut, filbert, pine nut, or peanut. In some embodiments, the nut is an almond. In some embodiments, the nut is raw. In some embodiments, the nut is contacted with said steam for between 6 to 16 seconds. In some embodiments, the bacteria on said nut are of the genus Salmonella. In some embodiments, the Salmonella are S. enterica Phage Type 30. In some embodiments, the nut is dried and cooled following contacting it with steam.

In another group of embodiments, the invention provides an apparatus for reducing bacterial contamination of nuts. The apparatus comprises an enclosed path permitting the nuts to descend from an upper elevation to a lower elevation, the path being positioned at an angle between and including 75 degrees to and including 90 degrees from the horizontal and having four or more orifices disposed along the enclosed path, and a means for introducing steam through said orifices into said path. In some embodiments, the means for introducing steam into the path through the orifices is a steam chamber fluidly connected to the orifices. In some embodiments, the path is defined by at least one baffle. In some embodiments, the at least one baffle is angled at 25 degrees to 60 degrees from the horizontal. In some embodiments, the at least one baffle is removable. In some embodiments, the apparatus further comprises a means for heating the steam chamber. In some embodiments, the means for heating said steam chamber is at least one tube contained heated liquid and permitting heat from said heated fluid to be conducted to said steam chamber. In some embodiments, the path is positioned to be at 90 degrees from the horizontal plane. In some embodiments, the apparatus further comprises a means for metering nuts to the enclosed vertical path to permit a volume controlled flow. In some embodiments, the apparatus further comprises a means for drying and cooling said nuts. In some embodiments, the apparatus further comprises a means for heating the heated liquid. In some embodiments, the means for drying and cooling said nuts includes a conveyor having air passing through the conveyor. In some embodiments, the apparatus is sectioned vertically to permit disassembly.

### BRIEF DESCRIPTION OF THE DRAWINGS

FIG. 1. FIG. 1 is a cross-sectional view of a nut ladder of the invention.

FIG. 2. FIG. 2 is an expanded view of the inlet portion of the nut ladder. The fan shapes designate steam entering the product flow ladder through multiple orifices in the sides of the ladder.

FIG. 3. FIG. 3 shows an exemplar nut ladder of the invention. The ladder is produced in two vertical sections, which have been separated to permit ready access for cleaning. After cleaning, the two sections are placed together for use in the methods of the invention.

### DETAILED DESCRIPTION OF THE INVENTION

The present invention relates to an improved process and apparatus for reducing microbial contamination on nuts. In preferred embodiments, the nuts are shelled.

In PCT application PCT/US2004/016178, WO 2004/105518, now a co-pending U.S. application filed under 35 U.S.C. §371 on even date herewith, two of the present inventors disclosed that devices known as almond ladders, designed for moving almonds from a higher location to a lower location without damage to the nuts, could be adapted to reduce bacterial contamination of almonds with less cost and energy use than by using a horizontal conveyor. That PCT application relates, in part, to the discovery that introducing steam into an enclosed ladder not only reduces the footprint needed to reduce the bacterial contamination of nuts passaged through the ladder, but also reduces the energy needed.

The process and apparatus disclosed in WO 2004/105518 is a significant advance in reducing the energy and other costs associated with reducing bacterial contamination of nuts. We have found, however, some inconsistency in achieving obtaining reductions of Salmonella SE PT30 of 4 logs or more. Any reduction in bacterial contamination is desirable and will improve public safety, and the methods and apparatus disclosed in WO 2004/105518 are therefore very useful. The improvements provided by the present invention, however, surprisingly improve the consistency of obtaining reductions of bacterial contamination. Further surprisingly, the present invention does so while significantly improving the energy efficiency of the apparatus, which has become increasingly important due to the recent increases in the cost of energy. Thus, the methods and apparatuses of the invention succeed in providing improved reduction of microbial contamination while reducing the cost of doing so. Additionally, the design of the apparatuses of the invention is considerably simpler and cheaper to produce. Thus, the present invention surprisingly provides a simpler and less expensive design and also provides more consistent killing of contaminating microorganisms.

As noted in the Background, there have been several recent instances of humans being affected by bacterial contamination of raw almonds. The discussion below uses almonds as an example. While almonds are a particularly preferred nut for use in connection with the methods and apparatuses disclosed herein, the invention can be used with respect to any nut as to which the practitioner wishes to reduce bacterial contamination, such as walnuts, cashews, pecans, macadamias, Brazil nuts, hazelnuts, filberts, pistachio nuts, and pine nuts. Peanuts are a legume, rather than a nut. In the mind of the public, however, peanuts are thought of as nuts and are the major component of many “nut” mixes; peanuts can be treated by the methods and the apparatuses of the invention and are included herein in the term “nut” herein unless otherwise stated. The nuts can be unshelled, and passaged through the inventive apparatus to reduce the chance that contamination will be passed to the nut in the process of removing the shell. In preferred embodiments, the nut is shelled. The nuts can be raw or cooked. In preferred embodiments, the nuts are raw.

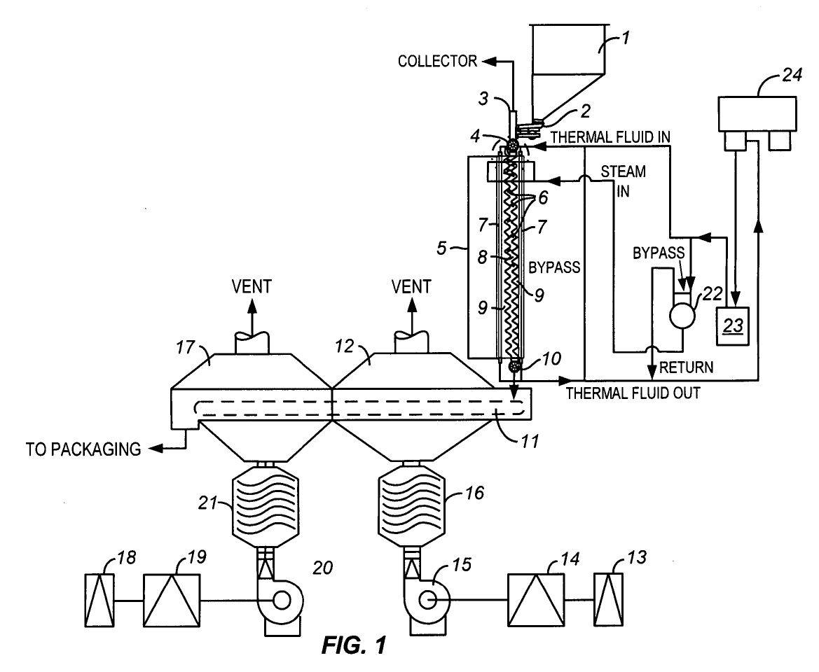

As noted, the apparatus used in the invention is adapted from a device called an “almond ladder”. Almond ladders are devices used in the art to control the vertical descent of almonds from one elevation to another to prevent damage to the shelled almonds during their descent. The ladders (sometimes referred to herein as “product ladders”) have a path permitting the nuts to descend along the path. For example, the ladders typically have a helical path or a “zigzag” path. FIG. 1, for example, shows a zigzag path or product ladder, 8. The path the nuts traverse through the ladder will be sometimes referred to herein as the “passage” through the ladder. The passage has an entry point, or inlet at the top by which the nuts enter (in FIG. 1, the inlet can be considered to be the point just below the top rotary valve, 4), and an outlet for the nuts at the bottom (in FIG. 1, the outlet can be considered to be the point just above the lower rotary valve 10).

The present invention uses ladders, or ladder-like apparatuses, to direct the descent of a nut through a path while the nut is contacted by steam to reduce bacteria or other microorganisms on its surface. The path of the ladders for use in the present invention can be any convenient configuration so long as the almond or other nut is retained within the ladder for a time sufficient to heat the nut to a temperature that will reduce the bacterial contamination by a desired amount, and, preferably, so that the nut is also not damaged by the descent. A relatively straight configuration for the path will cause the nut to accelerate more than if a zigzag path is used, and will tend to require a longer tube to expose the nut to the steam for a time sufficient to reduce contamination (the time the nut is contacted with steam in the path is referred to herein as the “dwell time”). Thus, the path is preferably configured to slow and control the passage of the nut through the device, and to avoid permitting the nut to build up enough speed to cause damage to the nut when it reaches the bottom of the vertical descent. A zigzag path is preferred since it is generally easier to produce.

While the discussion below uses a zigzag path as a basis for discussion, the person of skill will recognize that it could as easily relate to a path of any shape directing a nut from an inlet to an outlet through a continuous passage from a first, higher elevation to a second elevation lower in height than the first.

In appearance and shape, shelled almonds are generally elliptical when placed on a flat surface. The shelled almonds have a two major surfaces (one on the top and other on the back), and taper in reduced thickness from the center of the almond to the elliptical side edges. The shelled almonds are elongate about the major axis of their elliptical shape and have a width about the minor axis of their elliptical shape.

Turning now to a ladder for use in the invention, the ladder can include interior baffles along the path to break the fall of the nut as it passages from the higher to the lower elevation. The angle of the baffle determines how quickly the nut traverses the path from top to bottom of the ladder. Thus, a first baffle surface (or “ladder surface”) can be inclined at 35 degrees with respect to the vertical to allow the major surface of an almond descending the ladder to pass over the first baffle surface. The second baffle surface can be inclined at 35 degrees in the opposite direction with respect to the vertical. This allows the opposite major surface of a nut descending the ladder to pass over the second ladder surface. Alternating similarly angularly inclined ladder surfaces are provided to the ladder. The alternating angularly inclined surfaces enable gradual and metered nut descent without damage to the nuts. The apparatus can be designed to permit interior baffles of desired angles to be substituted. This permits the dwell time of the nut in the path to be changed as desired.

While the ladders themselves (as opposed to the baffle surfaces within the ladders) are generally described as being vertical, it will be recognized that the ladders do not have to be at precisely at a 90 degree angle from the horizontal plane to be effective. The footprint will be reduced, and the nuts will still descend, along a ladder positioned at any angle between 45 degrees and 90 degrees from the horizontal plane. In general, any angle that permits gravity to flow the nuts from the higher to the lower elevation without the application of external force (such as shaking the device or changing its angle during operation is suitable. Larger angles from the horizontal plane (that is, 80 degrees from the horizontal is larger than is 60 degrees) are preferred. In general, the angle from the horizontal should be 75 degrees or greater, more preferably 80, 81, 82, 83, 84, 85, 86, 87, 88, or 89 degrees, with each successively larger angle being more preferred. Ninety degrees is the most preferred position.

It is understood that the apparatus could be designed to shake or to change angles during use but this is generally not preferred since it would generally add to complexity of the device and therefore to the cost. The vertical orientation of the ladders and apparatuses of the invention distinguishes them from the primarily horizontal orientation of previously available devices.

Almond ladders are typically not enclosed. In the normal case, when almond ladders are used in an outdoor environment, enclosure occurs for the purpose of preventing moisture from having access to the flowing stream of almonds in the almond ladder. In WO 2004/105518, we disclosed that enclosing the ladder permits directing steam along the ladder to reduce bacterial contamination. Introducing counter flowing steam into the enclosed vertical path causes the exterior surface of descending almonds and, by extension, other nuts, to be heated sufficiently to pasteurize the exterior surface of the almonds in the enclosed vertical path. After this pasteurization, the almonds are dried.

We have found that using superheated steam counter flowing upwardly relative to the downwardly falling nuts provides an initial heating to the nuts. Without wishing to be bound by theory, it is surmised that it is the condensation of the steam on the surface of the almonds which is the vehicle of heat transfer. The condensing steam liberates its heat of vaporization to the descending nuts to effect a rapid heating of the surface of the nuts. This rapid heating kills pathogens on the nut surface without affecting the taste or other sensory characteristics of the nut.

Further, we have found that by counter flowing the nuts relative to the steam, minimal water transfer occurs between the surface of the nut and the passing steam. As the nuts must eventually be dried for storage or packaging, keeping the water content of the nut low reduces the energy that would otherwise be required for drying the nuts.

Moreover, we have discovered that maintaining nuts (initially heated by steam) at an elevated temperature, two beneficial effects occur simultaneously. First, by ensuring that the nuts reside at a temperature of over 190° F. for at least 30 to 45 seconds, the killing of pathogens (such as E. coli or Salmonella) improves by some 10,000 fold. Second, by maintaining the temperature but not adding water, drying of the nuts and of any skin on the nut begins to occur. When the full dwell time is achieved, finished drying can occur utilizing ambient air at about 70° F. to approximately 80° F. on a conveyor belt flowing at a rate just below that producing air flotation of the conveyed nuts.

Surprisingly, we have now discovered that maintaining an environment in the steam chamber slightly above atmospheric pressure creates a wet rather than dry steam. We have found that this allows higher dew point temperatures and increases the effectiveness of the latent heat of condensation phenomenon, thus reducing the time for pasteurization of the nuts. The wet steam and pressure create high dew point temperature conditions in the product flow ladder. The dew point temperatures reach 212° F.

We have previously thought that it was necessary to continue treating the nuts in a conditioning chamber following passage through the vertical ladder. We have now found that the improved effectiveness of the treatment in the vertical section eliminates the need for continued treatment in the conditioning chamber. This reduces the time that moisture and temperature are impacting the nuts, thus reducing the moisture that has to be dried from the nuts after pasteurization and reducing the chance that the sensory characteristics of the nuts will be adversely affected.

The desired dwell time in the steam ladder will vary depending on the type of nut and the moisture content of the nuts. The dwell time for any particular apparatus can be chosen by choosing the length and angle of the product ladder. For example, a longer pathway will increase the dwell time compared to a shorter one, and wider angles will permit the nuts to descend faster than will more acute ones. Whether any particular dwell time is sufficient or insufficient can be tested by determining whether the dwell time provides a 5 log kill of Salmonella SE PT30 using assays for measuring such kill rates as known in the art. See, e.g., Danyluk et al., J Food Protection 68(8):1613-1622 (2005). For example, for almonds, dwell time in the pasteurization section 5 can vary from 12 to 16 seconds, with a dwell time of 14 seconds being preferred. Nuts with higher moisture content will generally require higher dwell times since the presence of the moisture will slow the rise in temperature of the nut surface upon being contacted with the steam. Similarly, nuts with more crevasses or more irregular surfaces, such as walnuts, will generally require somewhat longer dwell times to achieve the desired reduction of bacterial contamination than will nuts with smoother surfaces, such as almonds. The dwell time for any particular nut can be readily determined. The practitioner will be aware that the goal is to minimize the dwell time to avoid changes to the sensory characteristics of the nut, while reducing bacterial contamination to the desired level.

In the product flow ladder, uniformly saturated steam rapidly condenses on the relatively cool surfaces of the almonds as they flow down the product ladder, such as the consecutive inclined surfaces of a zigzag flow ladder. The condensing steam releases latent heat of condensation on the surface of the nut. At the elevated dew point temperature conditions, the surface temperature of the nut nearly instantaneously approaches the dew point temperature, approximately 212° F. Further, this rapid heating leaves a minimal amount of water on the surface of the nut and reduces the chance the core of the nut will be heated significantly. This is important when it is considered that the almonds must be dried and cooled prior to the completion of the process.

Steam levels as little as one half pound over atmospheric pressure increase the “wetness” of the steam, which speeds the heat transfer to the nut and reduces the dwell time necessary for the nut to achieve any desired reduction of bacterial contamination. Pressures more than 3 pounds higher than atmospheric pressure become harder to contain and may require thicker walls on the equipment, studier gaskets, and the like, and are not preferred.

We have also now discovered that the means of introducing the steam and maintaining the process conditions can be simplified. In our prior configuration, multiple chambers of heated thermal fluids were used to surround the vertical product ladders, keeping the path within the ladder hot by conduction. Steam was introduced at the bottom of each chamber section.

In the device described in the PCT application referenced above, steam was introduced into the path at three points: at the top, in the middle, and at the bottom. We have now found that better pasteurization of the nuts is achieved by introducing the steam through orifices 6 at multiple points in the product ladder 8. The orifices are preferably distributed evenly throughout the path. The steam can conveniently be supplied by surrounding the product ladder with a steam filled chamber 9, rather than the fluid filled chambers previously used. The steam chamber 9 not only provides the source for the steam introduced into the orifices, 6, but also keeps the path hot by conduction through the walls of the ladder, 8. Moreover, where a steam chamber is used, the steam can be introduced wherever desired into the path by simple perforations in the wall between the steam chamber 9 and the path 8. In some embodiments where the ladder is designed to be separable into sections (as discussed below), a separate steam filled chamber 9 can be placed on either side of the product ladder 8. The steam chamber 9 is connected to the orifices in a manner that permits the flow of steam from the chamber 9 through the orifices 6 into the path 8 (this manner of connection is referred to herein as being “fluidly connected”). In an alternative embodiment, the steam is supplied by a tube containing steam running along or connected at points to the path 8, with perforations in the tube connected or attached to the orifices to permit flowing steam into the path, 8.

Surprisingly, this design not only improves the consistency of the pasteurization process but also notably improves the overall number of bacteria killed. Our testing indicates that kill rates of four or even of five logs can be consistently achieved. It is believed that introducing the steam at points along the product ladder path 8 reduces variations in temperature that might otherwise occur as the nuts traverse the length of the path 8. The magnitude of the improvement was a surprise in part because it was believed that, even in the prior configuration, the steam traversed the entire length of the product ladder and would heat the nuts throughout the path.

Further, we have now discovered we can further reduce the energy required for the overall process by flowing heated thermal fluid through vertical tubes 7 along the steam chambers 9. The fluid is heated to keep the sides of the steam chambers above 212° F. Heating the chamber sides with the heating tubes 7 decreases the amount of steam condensing on the sides of the chamber, and thereby reduces the amount of condensate that has be cleaned up. We have found that the thermal fluid loses a relatively modest amount of heat (only some 25° F. or so) as it cycles through the heating tubes back to the heater, making the energy use during the process surprisingly efficient. In an alternative embodiment, the sides of the steam chamber are heated by electric resistance heating wiring disposed along the sides of the chamber.

FIG. 1 shows one embodiment of the invention featuring a zigzag patterned nut ladder. In the embodiment shown, the nuts are in an optional product hopper 1, which discharges to vibrating feed pan 2 which in turn meters nuts through air-locking rotary valve 4 for the descent through product flow ladder 8. Optionally, the transition zone between the product feed pan 2 and the air-locking rotary valve 4 contains a product aspirator 3, which is connected to a dust collecting vacuum cyclone separator (not shown). Loose particulates from the freefalling nuts almonds are collected at the cyclone separator. This process minimizes the amount of loose particulates that could enter the pasteurizer and require more frequent cleaning.

Nuts descending through the product flow ladder 8 are contacted with steam entering through orifices 6 in the sides of the ladder. The steam enters the nut ladder 8 from a surrounding steam chamber 9. The steam is kept from condensing on the sides of the steam chamber 9 by heating tubes 7 running along the sides of the chamber 9. Nuts that have descended through the ladder 8 exit the pasteurization section 5 through a rotary valve 10. Completing the apparatus, fluid heater unit 23 supplies heat for both the flow of heated fluid to the thermal heating tubes in the pasteurizer 5 and for the heat exchanger in the steam generator 22 that supplies the steam for the pasteurizer. The steam supply is controlled to maintain set pressures and temperatures in the steam chamber. The rate of product flow through the product flow ladder and the incoming temperature and moisture will vary the demand for steam. Conventional return lines are provided for the fluid to thermal fluid reservoir 24. The thermal fluid reservoir must be elevated above the highest point where the thermal fluid enters the pasteurizer to prevent back flow of the fluid when the pasteurizer is shut off. The embodiment shown also includes a thermal fluid heater 23, as well as lines to carry the steam to the steam chamber 9 and lines to carry the thermal fluid from the thermal fluid heater 23 to the heating tubes 7, as well as lines for returning the thermal fluid from the heating tubes 7 to the fluid heater 23.

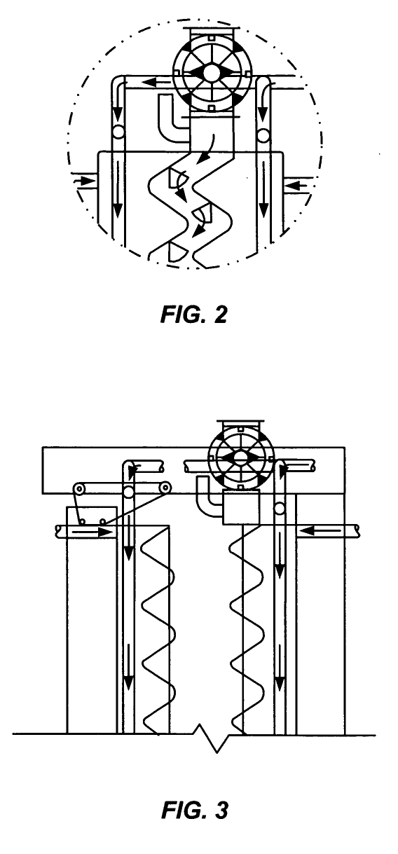

Referring to the expanded detail of FIG. 2, the enclosed product flow ladder formed by the confronted ladders (shown in more detail in FIG. 3) is shown with complementary surrounding steam chambers. Also shown are the steam orifices which allow uniform flow of steam at up to 15 psi into the enclosed product flow ladder. Further shown in FIG. 2 are the complementary sets of thermal fluid heating tubes flowing with heated thermal fluid in the range of 350° F. to 600° F. for maintaining heat in the steam chambers and the product flow ladder to control condensation on the inner surfaces of the product flow ladder.

Once the nuts have passed through the nut ladder, they are preferably dried and cooled for storage or packaging. After passage through the pasteurizer section 5, nuts are metered through air-locking rotary valve 10 on to the conveyor belt 11 of a first cooling/drying stage 12. This utilizes circulating filtered air from blower fan 15, optionally cooled through refrigeration coil 16, through conveyor 11. Air is introduced through conveyor 11 at a velocity that falls short of fluidly supporting the nuts. Specifically, air passage through the nuts on conveyor 11 causes the nuts to vibrate perceptively during conveyance while not interfering with conveyance.

Optionally, conveyor 11 continues into a second cooling/drying stage 17. The process of circulating cool filtered air is continued as described for the first cooling/drying stage 12. The conveyor speed and air temperature are controlled so that nuts will exit at acceptable moisture content and below ambient temperatures. This is desirable to prevent continued release of moisture from warm nuts after being packaged. Such conditions may allow the growth of molds on the nuts at the interface of the packaging material where moisture may condense.

One of the many advantages of the present invention is shown by the embodiment depicted in FIG. 3. One of the disadvantages of the currently available, horizontally configured systems for pasteurizing nuts is that they are based on a conveyor and are difficult to clean. As shown in FIG. 3, in some embodiments, the pasteurizing apparatuses of the invention are designed to separate into sections along their vertical axes. The sections can be moved apart to facilitate cleaning of the apparatuses.

Moreover, the horizontal systems currently available permit the steam used in the device to condense. This not only tends to create some difficulty in cleaning the apparatus and surroundings, but also wastes the heat applied to convert water to steam. The apparatuses of the present invention, which include enclosed steam chambers 9 reduce the escape of condensation, the consequent necessity for cleaning condensate up, and the loss of the heat invested in creating the steam. Use of the optional heating tubes 7 reduces steam condensation and further reduces any cleaning necessary to remove condensate. We believe that the heat lost through circulating the heated thermal fluid through the apparatuses of the invention is much less than the energy lost in permitting steam to condense in the horizontal systems previously available in the art.

It is understood that the examples and embodiments described herein are for illustrative purposes only and that various modifications or changes in light thereof will be suggested to persons skilled in the art and are to be included within the spirit and purview of this application and scope of the appended claims. All references cited herein, including articles, books, and abstracts, published or corresponding U.S. or foreign patent applications, issued U.S. or foreign patents, and any other references, are incorporated by reference herein.

What is claimed is:

1. A process for reducing bacterial contamination of a nut, comprising:
a. providing an enclosed path permitting said nut to descend from an upper elevation to a lower elevation, said path being positioned at an angle between and including 75 degrees to and including 90 degrees from the horizontal and having two or more orifices disposed along the path,
b. introducing steam into said enclosed path from said two or more orifices; and
c. introducing said nut into said enclosed path and contacting it with said steam for a time sufficient to kill bacteria on said nut,
thereby reducing bacterial contamination on said nut.

2. A process of claim 1, wherein said steam is introduced at a pressure higher than atmospheric pressure.

3. A process of claim 2, wherein said steam is maintained in said path as a pressurized wet steam so as to create a high dew point temperature approaching 212° F.

4. A process of claim 2, wherein said steam pressure is 3 pounds or less higher than atmospheric pressure.

5. A process of claim 1, wherein said nut is selected from the group consisting of almond, cashew, walnut, pecan, macadamia, Brazil nut, pistachio, hazelnut, filbert, pine nut, and peanut.

6. A process of claim 4, wherein said nut is an almond.

7. A process of claim 1, wherein said nut is raw.

8. A process of claim 1, wherein said nut is contacted with said steam for between 6 to 16 seconds.

9. A process of claim 1, wherein said bacteria on said nut are of the genus Salmonella.

10. A process of claim 1, wherein said Salmonella are S. enterica Phage Type 30.

11. A process of claim 1, wherein following step (c), the nut is dried and cooled.

12. An apparatus for reducing bacterial contamination of nuts, comprising:
a. an enclosed path permitting said nuts to descend from an upper elevation to a lower elevation, said path being positioned at an angle between and including 75 degrees to and including 90 degrees from the horizontal and having two or more orifices disposed along said enclosed path, and
b. a means for introducing steam into said path at said four or more orifices.

13. An apparatus of claim 12, further wherein said path is positioned to be at 90 degrees from the horizontal plane.

14. An apparatus of claim 12, further wherein said path is defined by at least one baffle.

15. An apparatus of claim 14, further wherein said at least one baffle is angled at 25 degrees to 60 degrees from the horizontal.

16. An apparatus of claim 14, further wherein said at least one baffle is removable.

17. An apparatus of claim 12, further wherein said means for introducing steam into said path through said four or more orifices is a steam chamber fluidly connected to said four or more orifices.

18. An apparatus of claim 17, further comprising a means for heating said steam chamber.

19. An apparatus of claim 18, further wherein said means for heating said steam chamber is at least one tube contained heated liquid and permitting heat from said heated fluid to be conducted to said steam chamber.

20. An apparatus of claim 12, further comprising a means for metering nuts to the enclosed vertical path to permit a volume controlled flow.

21. An apparatus of claim 12, further comprising a means for drying and cooling said nuts.

22. An apparatus of claim 19, further comprising a means for heating said heated liquid.

23. An apparatus of claim 21, wherein said means for drying and cooling said nuts includes a conveyor having air passing through the conveyor.

24. An apparatus of claim 12, further wherein the apparatus is sectioned vertically to permit disassembly.
